(19) United States
(12) Patent Application Publication
(10) Pub. No.: US 2009/0233782 A1
(43) Pub. Date: Sep. 17, 2009

(54) OPTICAL GLASS AND LENS USING THE SAME

(75) Inventor: Jun SASAI, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: ASAHI GLASS COMPANY, LIMITED, Tokyo (JP)

(21) Appl. No.: 12/404,039

(22) Filed: Mar. 13, 2009

Related U.S. Application Data
(63) Continuation of application No. PCT/JP07/67746, filed on Sep. 12, 2007.

(30) Foreign Application Priority Data
Sep. 14, 2006 (JP) 2006-249552

(51) Int. Cl. C03C 3/068

(52) U.S. Cl. 501/78

(57) ABSTRACT

The present invention has an object to provide an optical glass having excellent devitrification properties during high temperature forming and press moldability and capable of reducing weight and size of an optical system. The present invention relates to an optical glass comprising, in mass % on oxide basis; B₂O₃: 10 to 25%, SiO₂: 0.5 to 12%, La₂O₃: 17 to 38%, Gd₂O₃: 5 to 25%, ZnO: 8 to 20%, Li₂O: 0.5 to 3%, Ta₂O₅: 5 to 15% and WO₃: 3 to 15, wherein (SiO₂+B₂O₃)/(ZnO+Li₂O) value which is a mass ratio of the total content of SiO₂ and B₂O₃ to the total content of ZnO and Li₂O is from 1.35 to 1.90.

### TECHNICAL FIELD

The present invention relates to an optical glass of a high refractive index and low dispersion, and a lens using the same.

### BACKGROUND ART

In recent years, with the spread of high-definition and compact digital cameras and camera-equipped mobile phones, demands of reduction in weight and size in optical system are rapidly increasing. In order to meet those demands, optical design using an aspheric lens made of a high performance glass becomes the mainstream. In particular, a large aperture aspheric lens using a glass showing a high refractive index and low dispersion is important on optical design.

Glasses comprising B₂O₃ and La₂O₃ as main components have conventionally been known as a glass showing a high refractive index and low dispersion. However, such glasses had the problem that because a molding temperature is generally high, life of a noble metal protection film formed on WC mold matrix is short, and the durability of a molding mold is short, and also had the problem that molding cycle is long, resulting in low productivity.

To solve the above problems, a glass comprising Li₂O as a main component, besides B₂O₃ and La₂O₃ is known. However, there was the problem that because a rare earth element such as La₂O₃ is contained in a large amount, devitrification is liable to occur during high temperature molding process.

Furthermore, as a production method of an aspheric lens, a precision press molding method directly using a glass without polishing press surfaces becomes the mainstream from the points of productivity and production costs. In the precision press molding, a lower press molding temperature gives improved mold durability and shorter molding cycle to thereby increase the productivity. Therefore, an optical glass having a low molding temperature is desired.

When the content of an alkali metal or alkaline earth metal component as a glass component is increased to lower the molding temperature, thermal expansion coefficient of an optical glass becomes large. WC, ceramics and the like used as a mold has a thermal expansion coefficient far smaller than that of an optical glass. As a result, a thermal strain due to the difference in a thermal expansion coefficient between the mold and the optical glass is generated in an optical part as a molded product. By the molding strain, optical properties vary, and in the worst case, defects such as cracks are generated in a molded product. Therefore, an optical glass is required to have a lower molding temperature, and simultaneously a low thermal expansion coefficient.

To solve the above problems, Patent Document 1 proposes a glass comprising B₂O₃—SiO₂—La₂O₃—Gd₂O₃—ZnO—Li₂O—ZrO₂ as main components. However, any composition of a high refractive index glass having a refractive index of 1.79 or more is not specifically described in the Examples, and additionally there is the problem that a molding temperature is high.

Patent Document 2 proposes an optical glass for mold press molding comprising B₂O₃—La₂O₃—ZnO—Ta₂O₅—WO₃ as main components, wherein n_{d} is from 1.75 to 1.85, ν_{d} is 35 or more and a softening point is 700° C. or lower. However, this glass is not sufficient in the aspect of the balance in optical properties, devitrification properties during high temperature process and low thermal expansion properties.

Patent Document 1: JP-A-2003-201143

Patent Document 2: JP-A-2005-15302

### DISCLOSURE OF THE INVENTION

### Problems to be Solved by the Invention

The present invention has an object to provide an optical glass which has optical properties of high refractive index and low dispersion, has a low molding temperature, is difficult to devitrify and has excellent moldability.

### Means for Solving the Problems

The present invention provides an optical glass comprising, in mass % on oxide basis;

B₂O₃: 10 to 25%

SiO₂: 0.5 to 12%

La₂O₃: 17 to 38%

Gd₂O₃: 5 to 25%

ZnO: 8 to 20%

Li₂O: 0.5 to 3%

Ta₂O₅: 5 to 15%, and

WO₃: 3 to 15,

wherein the optical glass has a (SiO₂+B₂O₃)/(ZnO+Li₂O) value, which is a mass ratio of the total content of SiO₂ and B₂O₃ to the total content of ZnO and Li₂O, of from 1.35 to 1.90.

### ADVANTAGEOUS EFFECTS OF THE INVENTION

The optical glass of the present invention (hereinafter referred to as “the present glass”) has a high refractive index, preferably a refractive index n_{d} to d line of from 1.79 to 1.83, and an Abbe number ν_{d} of from 38 to 45.

The present glass has a molding temperature as low as 650° C. or lower and a liquidus temperature, which is the maximum temperature at which devitrification does not occur, as low as 1,000° C. or lower. Therefore, the present glass has excellent formability in a high temperature process. Furthermore, a thermal expansion coefficient of the present glass is α=66 to 82 (×10⁻⁷ K⁻¹) which is low as compared with an optical glass of the same system, and therefore the difference in a thermal expansion coefficient relative to a press mold such as WC system is small. As a result, rejection rate of molded products due to thermal strain can considerably be reduced. Moreover, owing to the above-mentioned reasons, optical products such as a lens can be produced with good productivity, and this also contributes to reduction in production costs.

The present glass can be used as a glass substrate requiring a high refractive index. Specifically, examples thereof include a substrate for increasing a light extraction efficiency for organic LED. In general substrate glasses such as soda lime glass, borosilicate glass and non-alkali glass, a refractive index is less than 1.6. Therefore, the extraction efficiency of light generated in an organic layer by reflection at the interface with a transparent conductive film such as ITO having high refractive index (refractive index: about 1.9) is decreased, but when the present glass is used, it is possible to improve the light extraction efficiency. Furthermore, in the present glass, mold molding at a low temperature is possible while achieving a high refractive index. Therefore, imparting a texture to a surface can easily be carried out, and this makes it possible to further improve the light extraction efficiency.

### BEST MODE FOR CARRYING OUT THE INVENTION

The reasons of setting each component range of the present glass are described below.

In the present glass, B₂O₃ is a component to form a glass backbone and to lower a liquidus temperature T_{L}, and is an essential component. In the present glass, the B₂O₃ content is from 10 to 25 mass % (hereinafter abbreviated as “%” for brevity). Where the 3203 content is less than 10%, vitrification is difficult or the liquidus temperature T_{L} becomes high, which is not preferred. To lower the liquidus temperature T_{L}, the B₂O₃ content is preferably 12% or more. The B₂O₃ content is more preferably 13% or more, and further preferably 14% or more. When the B₂O₃ content is 15% or more, the liquidus temperature is lowered, and additionally, the Abbe number can be increased, which is particularly preferred.

On the other hand, in the present glass, where the B₂O₃ content exceeds 25%, the refractive index n_{d} may be possibly low, or the chemical durability such as resistance to water may possibly deteriorate. It is preferred in the present glass that the B₂O₃ content is 23% or less. Where the refractive index n_{d} is desired to increase, the B₂O₃ content is preferably 21% or less, and more preferably 20% or less.

In the present glass, ZnO is a component to stabilize a glass and to lower a molding temperature Tₚ or a melting temperature, and is an essential component. In the present glass, the ZnO content is from 8 to 20%. Where the ZnO content is less than 8%, the glass may be possibly instable, or the molding temperature may be possibly high. The ZnO content is preferably 10% or more, and more preferably 11% or more. On the other hand, in the present glass, where the ZnO content exceeds 20%, the stability of the glass may be possibly poor, and the chemical durability may possibly deteriorate. The ZnO content is preferably 19% or less, and more preferably 18% or less.

In the present glass, La₂O₃ is a component to increase a refractive index n_{d} and to improve chemical durability, and is an essential component. In the present glass, the La₂O₃ content is from 17 to 38%. Where the La₂O₃ content is less than 17%, the refractive index n_{d} may be possibly too low. The La₂O₃ content is preferably 19% or more, and more preferably 21% or more. On the other hand, where the La₂O₃ content exceeds 38%, it may be possibly difficult to vitrify. As a result, the molding temperature may be possibly high or the liquidus temperature T_{L} may be possibly high. The La₂O₃ content is preferably 35% or less, and more preferably 33% or less.

In the present glass, Gd₂O₃ is a component to increase a refractive index n_{d} and to improve chemical durability, similar to La₂O₃, and is an essential component. In the present glass, the Gd₂O₃ content is from 5 to 25%. Where the Gd₂O₃ content is less than 5%, the refractive index n_{d} is low. The Gd₂O₃ content is preferably 6% or more, and more preferably 7% or more. On the other hand, where the Gd₂O₃ content exceeds 25%, it may be possibly difficult to vitrify. As a result, the molding temperature may be possibly high, or the liquidus temperature T_{L} may be possibly high. The Gd₂O₃ content is preferably 22% or less, and more preferably 20% or less.

In the present glass, the total amount of the La₂O₃ content and the Gd₂O₃ content is preferably from 33 to 50%, Where the total amount is less than 33%, the refractive index n_{d} may be possibly low, or chemical durability may possibly deteriorate. The total amount is preferably 35% or more, and more preferably 37% or more. On the other hand, where the total amount exceeds 50%, it may be possibly difficult to vitrify. As a result, the molding temperature may be possibly high, or the liquidus temperature T_{L} may be possibly high. The total amount is preferably 47% or less, and more preferably 45% or less.

In the present glass, Li₂O is a component to stabilize a glass and to lower a molding temperature and a melting temperature, and is an essential component. In the present glass, the Li₂O content is from 0.5 to 3%. Where the Li₂O content is less than 0.5%, the molding temperature or the melting temperature may be possibly too high. The Li₂O content is preferably 1.1% or more, and more preferably 1.3% or more. On the other hand, where the Li₂O content exceeds 3%, it is liable to vitrify, and deterioration of chemical durability and volatilization of components during melting may be possibly vigorous. The Li₂O content is preferably 2.5% or less, and more preferably 2.3% or less.

In the present glass, Ta₂O₅ is a component to stabilize a glass, to increase a refractive index n_{d} and to suppress devitrification during high temperature forming, and is an essential component. In the present glass, the Ta₂O₅ content is from 5 to 15%. Where the Ta₂O₅ content is less than 5%, the refractive index n_{d} may be possibly too low, or the liquidus temperature T_{L} may be possibly too high. The Ta₂O₅ content is preferably 7% or more, and more preferably 8% or more. On the other hand, the Ta₂O₅ content exceeds 15%, the molding temperature may be possibly too high, or the Abbe number ν_{d} may be possibly too small. The Ta₂O₅ content is preferably 14% or less, and more preferably 13% or less.

In the present glass, WO₃ is a component to stabilize a glass, to increase a refractive index n_{d} and to suppress devitrification during high temperature forming, and is an essential component. In the present glass, the WO₃ content is from 3 to 15%. Where the WO₃ content is less than 3%, the refractive index n_{d} may be possibly low, and the liquidus temperature T_{L} may be possibly too high. The WO₃ content is preferably 4% or more, and more preferably 5% or more. On the other hand, where the WO₃ content exceeds 15%, the molding temperature may be possibly high, and the Abbe number ν_{d} may be possibly too small. The WO₃ content is preferably 14% or less, and more preferably 13% or less.

In the present glass, SiO₂ is a component to stabilize a glass, or to suppress devitrification during high temperature forming, and is an essential component. In the present glass, the SiO₂ content is from 0.5 to 12%. Where the SiO₂ content exceeds 12%, the molding temperature may be possibly high, and the refractive index n_{d} may be possibly too low. The SiO₂ content is preferably 10% or less, and more preferably 9% or less.

On the other hand, when it is desired to suppress devitrification during high temperature forming or to adjust a viscosity, the SiO₂ content is 0.5% or more. The SiO₂ content is preferably 2% or more, and more preferably 4% or more.

The present inventors have found that a low molding temperature, a low liquidus temperature and thermal expansion coefficient can be made compatible when the mass ratio of the total amount of the B₂O₃ content and the SiO₂ content, which are network forming oxide components of a glass, relative to the total amount of the Li₂O content and the ZnO content, which are a monovalent or divalent glass modifying oxide component, (SiO₂+B₂O₃)/(ZnO+Li₂O) (hereinafter referred to as a “network modification ratio”), is adjusted to a specific value.

In the present glass, the network modification ratio is from 1.35 to 1.90. Where the network modification ratio is less than 1.35 or exceeds 1.90, it is difficult to make compatible a low molding temperature and a low liquidus temperature. The lower limit of the network modification ratio is preferably 1.38 or more, and more preferably 1.40 or more. On the other hand, the upper limit of the network modification ratio is preferably 1.85 or less, and more preferably 1.80 or less.

In the present glass, ZrO₂ is not an essential component, but may be contained in an amount of from 0 to 5% for stabilizing a glass, increasing a refractive index n_{d}, suppressing devitrification during high temperature forming, and the like. Where the ZrO₂ content exceeds 5%, the molding temperature may be possibly too high, or the Abbe number ν_{d} may be possibly too small. The ZrO₂ content is preferably 4% or less, and more preferably 3% or less. On the other hand, to obtain the effect of addition, the ZrO₂ content is more preferably 0.1% or more, and further preferably 0.2% or more.

In the present glass, TiO₂ is not an essential component, but may be contained in an amount of from 0 to 5% for stabilizing a glass, increasing a refractive index n_{d}, suppressing devitrification during high temperature forming, and the like. Where the TiO₂ content exceeds 5%, the Abbe number ν_{d} may be possibly too small, or the transmittance may be possibly decreased. The TiO₂ content is more preferably 3% or less.

In the present glass, Nb₂O₅ is not an essential component, but may be contained in an amount of from 0 to 5% for stabilizing a glass, increasing a refractive index n_{d}, suppressing devitrification during high temperature molding, and the like. Where the Nb₂O₅ content exceeds 5%, the Abbe number ν_{d} may be possibly too small, or the transmittance may be possibly decreased. The Nb₂O₅ content is preferably 3% or less.

In the present glass, Y₂O₃ and Yb₂O₃ each are not essential components, but may be contained in an amount of from 0 to 10% for increasing a refractive index n_{d}, suppressing devitritication during high temperature forming, and the like. Where the total amount of those exceeds 10%, the glass may rather be possibly unstable, or the molding temperature may be possibly too high. The total amount of Y₂O₃ and Yb₂O₃ is preferably 7% or less.

In the present glass, Al₂O₃, Ga₂O₃, GeO₂ and P₂O₅ each are not essential components, but may be contained in an amount of from 0 to 10% for the purpose of stabilizing a glass, adjusting a refractive index n_{d}, and the like. Where the total amount of Al₂O₃, Ga₂O₃, GeO₂ and P₂O₅ exceeds 10%, the Abbe number ν_{d} may be possibly too low. The total amount of Al₂O₃, Ga₂O₃, GeO₂ and P₂O₅ is more preferably 8% or less, and further preferably 6% or less.

In the present glass, where Al₂O₃, Ga₂O₃ and GeO₂ are contained, the total amount of the respective contents of Al₂O₃, Ga₂O₃, GeO₂ and B₂O₃ is preferably from 15 to 35%. Where the total amount is less than 15%, vitrification may be possibly difficult, or the liquidus temperature T_{L} may be possibly high. The total amount is more preferably 18% or more, and further preferably 22% or more.

On the other hand, the total amount of the respective contents of Al₂O₃, Ga₂O₃, GeO₂ and B₂O₃ exceeds 35%, the refractive index n_{d} may be possibly low, or the molding temperature may be possibly high. The total amount is more preferably 32% or less, and further preferably 29% or less.

In the present glass, BaO, SrO, CaO and MgO each are not essential components, but each may be contained in an amount of from 0 to 15% for stabilizing a glass, increasing an Abbe number ν_{d}, lowering a molding temperature, decreasing specific gravity and the like. Where the content of each of BaO, SrO, CaO and MgO exceeds 15%, the glass may be possibly unstable, or the refractive index n_{d} may be possibly low.

Where BaO, SrO, CaO and MgO are contained, the total amount of the respective contents of BaO, SrO, CaO, MgO and ZnO is desirably from 8 to 25%. Where the total amount is less than 8%, the glass may be possibly unstable, or the molding temperature may be possibly too high. The total amount is more preferably 10% or more, and further preferably 11% or more. On the other hand, where the total amount exceeds 20%, the glass may be possibly rather unstable, the refractive index n_{d} may be possibly low, or the chemical durability may possibly deteriorate. The total amount is more preferably 19% or less, and further preferably 18% or less.

In the present glass, where it is desired, for example, to further suppress devitrification during high temperature forming, the glass preferably comprises B₂O₃; 15 to 20%, SiO₂: 3 to 10%, La₂O₃: 21 to 33%, Gd₂O₃: 7 to 19%, ZnO: 8 to 19%, Li₂O: 1.2 to 2.4%, Ta₂O₅: 8 to 14%, and WO₃: 5 to 13%, wherein the network modification ratio is from 1.38 to 1.82. When ZrO₂ and/or TiO₂ are further added to this composition in an amount of from 0.2 to 4%, the devitrification suppression effect is further secured, which is hence preferred.

The present glass consists essentially of the above-described components, but may contain other components to the extent not impairing the objects of the present invention. Where such other components are contained, the total amount of the contents of the other components is preferably 10% or less, more preferably 8% or less, and further preferably 6% or less or 5% or less.

The present glass may contain Sb₂O₃ in an amount of, for example, from 0 to 1% for the purpose of refining and the like. Furthermore, each component of Na₂O, K₂O, Rb₂O or Cs₂O may be contained in a total amount of from 0 to 5% for the purpose of further stabilizing a glass, adjusting a refractive index n_{d}, adjusting specific gravity, lowering a melting temperature, and the like. Where the total amount of each component of Na₂O, K₂O, Rb₂O or Cs₂O exceeds 5%, the glass may be possibly unstable, the refractive index n_{d} may be possibly low, the hardness may be possibly small, or the chemical durability may possibly deteriorate. Where importance is attached to the hardness or chemical durability, it is preferred that none of each component of Na₂O, K₂O, Rb₂O and Cs₂O is contained.

In the present glass, optional components other than above can be selected according to the respective required properties. For example, where importance is attached to the high refractive index n_{d} and the low glass transition point T_{g}, SnO may be contained in an amount up to 4%. Similarly, where importance is attached to the high refractive index, TeO₂ and/or Bi₂O₃ may be contained in an amount of form 0 to 6% singly or as the total amount. Where the content of TeO₂ and/or Bi₂O₃ exceeds 6%, the glass may be possibly unstable, or the transmittance may be possibly markedly decreased. However, where the Abbe number ν_{d} is desired to increase, it is preferred that none of TeO₂ and Bi₂O₃ is contained.

To reduce an environmental load, it is preferred that the present glass does not substantially contain any of lead (PbO), arsenic (As₂O₃) and thallium (Tl₂O) as components. Where fluorine is contained, it increases a thermal expansion coefficient, it adversely affects releasability and moldability, and the component is liable to vaporize. Therefore, there are the problems that the composition of the optical glass is liable to be heterogeneous, the durability of a mold such as a release film deteriorates, and the like. As a result, it is preferred that the present glass does not substantially contain fluorine.

It is preferred that the present glass does not contain Fe₂O₃ for the reasons of prevention of coloration and the like, but in general, Fe₂O₃ is unavoidably incorporated from raw materials. Even in this case, it is preferred in the present glass that Fe₂O₃ content is 0.0001% or less.

As the optical properties of the present glass, the refractive index n_{d} is preferably from 1.79 to 1.83. When the refractive index n_{d} is 1.79 or more, such a glass is suitable to downsize a lens, which is hence preferred. The refractive index n_{d} is more preferably 1.80 or more. On the other hand, where the refractive index n_{d} exceeds 1.83, the Abbe number becomes too small, which is not preferred. The refractive index n_{d} of the present glass is more preferably 1.82 or less. The Abbe number ν_{d} is preferably from 38 to 45 when the refractive index n_{d} is from 1.79 to 1.83, and more preferably from 39 to 44 when the refractive index n_{d} is from 1.80 to 1.82.

In the present specification, the molding temperature Tₚ means a value calculated from a glass transition temperature T_{g} and a yield point At by the equation of

Tₚ−At+(At−T_{g})/2.

When the molding temperature Tₚ of the present glass is 650° C. or lower, it facilitates precision press molding, which is hence preferred. Where the molding temperature Tₚ exceeds 650° C., there are the possibilities that part of components of a preform which is a product to be molded in press molding evaporates to induce a damage of mold members or release film, so that the durability of a mold deteriorates, and additionally that the press molding productivity itself deteriorates. The molding temperature Tₚ of the present glass is more preferably 645° C. or lower, and further preferably 640° C. or lower.

Regarding the thermal expansion coefficient α of the optical glass, it is preferred that the difference from the thermal expansion coefficient of a mold, which is, for example, 40 to 50×10⁻⁷ K⁻¹ in WC system, is not so large. In the present glass, the thermal expansion coefficient α is preferably 82×10⁻⁷ K⁻¹ or less. Where the thermal expansion coefficient α exceeds 82×10⁻⁷ K⁻¹, defects such as cracks are liable to occur during press molding, and where pressure conditions are made mild to avoid cracks and the like, shape transferability deteriorates by molding sink. In the present glass, the thermal expansion coefficient α is further preferably 80×10⁻⁷ K⁻¹ or less.

On the other hand, where the thermal expansion coefficient α of the present glass becomes too small, a mold and an optical part are difficult to be released in a cooling process of press molding, and in the worst case, the optical part may be possibly fixed to the mold, resulting in molding defect. Therefore, in the present glass, the thermal expansion coefficient α is preferably 66×10⁻⁷ K⁻¹ or more, and more preferably 67×10⁻⁷ K⁻¹ or more. In the present description, the thermal expansion coefficient α means a value in a temperature range of from 50 to 350° C.

The liquidus temperature T_{L} of the present glass is preferably 1,000° C. Or lower. Where the liquidus temperature T_{L} exceeds 1,000° C., a product to be molded is liable to devitrify during high temperature forming, and carbon or heat-resistant alloy used as a receiver mold of high temperature forming deteriorates, which is not preferred. The liquidus temperature T_{L} of the present glass is more preferably 990° C. or lower, and further preferably 980° C. or lower. The liquidus temperature T_{L} is defined as the maximum temperature at which a crystal solidified product is not formed from a glass melt when held at a certain temperature.

The present glass has the above-described properties. Therefore, the glass is easily optically designed, and is suitable for optical parts, particularly an aspheric lens used in digital cameras or the like.

### EXAMPLES

Specific embodiments of the present invention are described by the Examples (Runs 1 to 68) and the Comparative Examples (Runs 69 to 72), but the invention is not limited to those.

A raw material preparation method was as follows. Raw materials shown below were mixed such that glasses having compositions shown in the Tables are obtained, placed in a platinum crucible, and melted at 1,100 to 1,300° C. for 1 hour. In this case, a molten glass was stirred with a platinum-made stirrer for 0.5 hour to homogenize the same. The homogenized molten glass was flown out the crucible and molded into a plate. The plate was held at a temperature of T_{g}+10° C. for 4 hours, and then annealed to room temperature at a cooling rate of −1° C./min.

As raw materials, guaranteed reagents manufactured by Kanto Chemical Co., Inc. were used as boron oxide, aluminum oxide, lithium carbonate, sodium carbonate, zirconium dioxide, zinc oxide, magnesium oxide, calcium carbonate and barium carbonate. Reagents having a purity of 99.9% manufactured by Shin-Etsu Chemical Co., Ltd. were used as lanthanum oxide and gadolinium oxide. Reagents having a purity of 99.9% manufactured by Kojundo Chemical Lab. Co., Ltd. were used as tantalum oxide, silicon dioxide, tungsten oxide and niobium oxide.

A glass transition point T₉, a yield point At (unit: ° C.), an average linear expansion coefficient α at 50 to 300° C. (unit: 10⁻⁷ K⁻¹), a refractive index n_{d} at a wavelength of 587.6 nm (d line), an Abbe number ν_{d}, a liquidus temperature T_{L} (unit: ° C.) and a specific gravity d were measured on the glasses obtained. Those measurement methods are described below.

Thermal properties (T_{g}, At and α): A sample processed into a columnar shape having a diameter of 5 mm and a length of 20 mm was measured with a thermo-mechanical analyzer (a product of MAC Science Co., Ltd., trade name: DIALTOMETER 5000) at a temperature rising rate of 5° C./min

Optical properties (n_{d} and ν_{d}): A sample processed into a rectangular solid shape having a side of 20 mm and a thickness of 10 mm was measured with a precision refractometer (a product of Kalnew Optical Industry Co., Ltd., trade name: KPR-2). The measurement value was obtained up to five places of decimals. The refractive index (n_{d}) was described by rounding to two decimal places, and the Abbe number (ν_{d}) was described by rounding to one decimal place.

Liquidus temperature T_{L}: A sample processed into a cube shape having one side of 10 mm was placed on a platinum pan, and held in an electric furnace set to a certain temperature for 1 hour. The sample was taken out of the furnace, and was observed with an optical microscope of 10 magnifications. The maximum temperature at which precipitation of crystal was not observed was considered as a liquidus temperature T_{L}. When the liquidus temperature T_{L} exceeds 1,000° C., it was expressed as “Exceeding 1000”.

As devitrification properties, a satisfactory glass in which devitrification (precipitation of crystal) was not observed at a liquidus temperature of 1,000° C. is indicated by “o”, and a glass in which devitrification (precipitation of crystal) was observed is indicated by “x”.

TABLE 1

| | Number | | | | |
|---|---|---|---|---|---|
| | Run 1 | Run 2 | Run 3 | Run 4 | Run 5 |
| B₂O₃ | 19.5 | 19.6 | 19.5 | 19.4 | 19.3 |
| SiO₂ | 5.31 | 5.35 | 5.32 | 5.29 | 5.26 |
| La₂O₃ | 26.4 | 26.6 | 26.4 | 26.3 | 26.1 |
| Gd₂O₃ | 13.3 | 13.5 | 13.4 | 13.3 | 13.2 |
| ZnO | 16.7 | 15.0 | 14.9 | 14.8 | 14.7 |
| Li₂O | 1.34 | 1.69 | 1.68 | 1.67 | 1.66 |
| TiO₂ | 0.00 | 0.59 | 1.18 | 1.76 | 2.33 |
| ZrO₂ | 1.81 | 1.83 | 1.82 | 1.81 | 1.80 |
| Ta₂O₅ | 9.75 | 9.84 | 9.78 | 9.73 | 9.67 |
| Nb₂O₅ | 0.00 | 0.00 | 0.00 | 0.00 | 0.00 |
| WO₃ | 5.97 | 6.02 | 5.99 | 5.95 | 5.92 |
| Total | 100 | 100 | 100 | 100 | 100 |
| Network modification | 1.38 | 1.50 | 1.50 | 1.50 | 1.50 |
| ratio | | | | | |
| Refractive index n_{d} | 1.79 | 1.79 | 1.80 | 1.80 | 1.81 |
| Abbe number ν_{d} | 43.6 | 43.0 | 42.3 | 41.2 | 40.6 |
| Glass transition point | 564 | 557 | 557 | 558 | 558 |
| T_{g}/° C. | | | | | |
| Yield point Aₜ/° C. | 615 | 608 | 609 | 609 | 610 |
| Liquidus temperature | 960 | 960 | 960 | 940 | 980 |
| T_{L}/° C.T_{L}/° C. | | | | | |
| Thermal expansion | 75.8 | 77.0 | 76.4 | 75.9 | 75.3 |
| coefficient α | | | | | |
| Molding temperature | 640 | 634 | 634 | 635 | 635 |
| Tₚ/° C. | | | | | |
| Devitrification properties | ∘ | ∘ | ∘ | ∘ | ∘ |

TABLE 2

| | Number | | | | |
|---|---|---|---|---|---|
| | Run 6 | Run 7 | Run 8 | Run 9 | Run 10 |
| B₂O₃ | 19.4 | 17.3 | 16.9 | 16.6 | 16.4 |
| SiO₂ | 5.30 | 7.69 | 7.50 | 7.39 | 7.27 |
| La₂O₃ | 26.3 | 25.5 | 24.9 | 24.5 | 24.1 |
| Gd₂O₃ | 13.3 | 12.9 | 12.6 | 12.4 | 12.2 |
| ZnO | 14.8 | 14.4 | 14.0 | 13.8 | 13.6 |
| Li₂O | 1.67 | 1.62 | 1.58 | 1.55 | 1.53 |
| TiO₂ | 0.59 | 0.57 | 0.55 | 0.55 | 0.54 |
| ZrO₂ | 1.81 | 1.75 | 1.71 | 1.68 | 1.66 |
| Ta₂O₅ | 9.74 | 12.6 | 12.3 | 12.1 | 11.9 |
| Nb₂O₅ | 0.98 | 0.00 | 0.00 | 0.00 | 0.00 |
| WO₃ | 5.96 | 5.77 | 8.04 | 9.50 | 10.9 |
| Total | 100 | 100 | 100 | 100 | 100 |
| Network modification | 1.50 | 1.57 | 1.57 | 1.57 | 1.57 |
| ratio | | | | | |
| Refractive index n_{d} | 1.80 | 1.79 | 1.80 | 1.80 | 1.80 |
| Abbe number ν_{d} | 42.2 | 42.3 | 41.7 | 41.9 | 40.5 |
| Glass transition point | 557 | 565 | 566 | 567 | 567 |
| T_{g}/° C. | | | | | |
| Yield point Aₜ/° C. | 608 | 616 | 617 | 618 | 619 |
| Liquidus temperature | 980 | 980 | 1000 | 990 | 990 |
| T_{L}/° C. | | | | | |
| Thermal expansion | 77.5 | 76.0 | 74.9 | 74.2 | 73.5 |
| coefficient α | | | | | |
| Molding temperature | 634 | 642 | 643 | 644 | 645 |
| Tₚ/° C. | | | | | |
| Devitrification properties | ∘ | ∘ | ∘ | ∘ | ∘ |

TABLE 3

| | Number | | | | |
|---|---|---|---|---|---|
| | Run 11 | Run 12 | Run 13 | Run 14 | Run 15 |
| B₂O₃ | 16.1 | 19.5 | 19.5 | 19.4 | 19.3 |
| SiO₂ | 7.16 | 5.32 | 5.30 | 5.28 | 5.26 |
| La₂O₃ | 23.7 | 31.2 | 28.8 | 23.8 | 21.4 |
| Gd₂O₃ | 12.0 | 8.0 | 10.7 | 15.9 | 18.5 |
| ZnO | 13.4 | 14.9 | 14.9 | 14.8 | 14.7 |
| Li₂O | 1.50 | 1.68 | 1.67 | 1.66 | 1.66 |
| TiO₂ | 0.53 | 1.77 | 1.76 | 1.75 | 1.75 |
| ZrO₂ | 1.63 | 1.82 | 1.81 | 1.80 | 1.80 |
| Ta₂O₅ | 11.7 | 9.78 | 9.75 | 9.70 | 9.67 |
| Nb₂O₅ | 0.00 | 0.00 | 0.00 | 0.00 | 0.00 |
| WO₃ | 12.3 | 5.99 | 5.97 | 5.94 | 5.92 |
| Total | 100 | 100 | 100 | 100 | 100 |
| Network modification | 1.57 | 1.50 | 1.50 | 1.50 | 1.50 |
| ratio | | | | | |
| Refractive index n_{d} | 1.81 | 1.80 | 1.80 | 1.80 | 1.80 |
| Abbe number ν_{d} | 40.2 | 41.3 | 41.4 | 41.4 | 41.4 |
| Glass transition point | 568 | 556 | 557 | 559 | 560 |
| T_{g}/° C. | | | | | |
| Yield point Aₜ/° C. | 620 | 607 | 608 | 610 | 611 |
| Liquidus temperature | 990 | 950 | 940 | 970 | 1000 |
| T_{L}/° C. | | | | | |
| Thermal expansion | 72.8 | 76.6 | 76.2 | 75.5 | 75.2 |
| coefficient α | | | | | |
| Molding temperature | 646 | 633 | 634 | 636 | 637 |
| Tₚ/° C. | | | | | |
| Devitrification properties | ∘ | ∘ | ∘ | ∘ | ∘ |

TABLE 4

| | Number | | | | |
|---|---|---|---|---|---|
| | Run 16 | Run 17 | Run 18 | Run 19 | Run 20 |
| B₂O₃ | 17.2 | 16.7 | 16.3 | 17.3 | 17.5 |
| SiO₂ | 8.71 | 8.50 | 8.30 | 8.79 | 8.88 |
| La₂O₃ | 28.3 | 28.8 | 29.2 | 28.6 | 28.9 |
| Gd₂O₃ | 10.5 | 11.5 | 12.5 | 10.6 | 10.7 |
| ZnO | 14.6 | 14.3 | 13.9 | 13.6 | 12.5 |
| Li₂O | 1.65 | 1.61 | 1.57 | 1.88 | 2.12 |
| TiO₂ | 1.74 | 1.69 | 1.65 | 1.75 | 1.77 |
| ZrO₂ | 1.79 | 1.74 | 1.70 | 1.80 | 1.82 |
| Ta₂O₅ | 9.61 | 9.37 | 9.15 | 9.70 | 9.80 |
| Nb₂O₅ | 0.00 | 0.00 | 0.00 | 0.00 | 0.00 |
| WO₃ | 5.88 | 5.74 | 5.60 | 5.94 | 6.00 |
| Total | 100 | 100 | 100 | 100 | 100 |
| Network modification | 1.59 | 1.59 | 1.59 | 1.69 | 1.80 |
| ratio | | | | | |
| Refractive index n_{d} | 1.79 | 1.80 | 1.80 | 1.79 | 1.79 |
| Abbe number ν_{d} | 41.6 | 41.6 | 41.6 | 41.7 | 41.8 |
| Glass transition point | 564 | 565 | 569 | 559 | 556 |
| T_{g}/° C. | | | | | |
| Yield point Aₜ/° C. | 615 | 617 | 623 | 611 | 609 |
| Liquidus temperature | 950 | 970 | 960 | 950 | 980 |
| T_{L}/° C. | | | | | |
| Thermal expansion | 75.0 | 76.1 | 79.0 | 76.1 | 76.6 |
| coefficient α | | | | | |
| Molding temperature | 641 | 642 | 650 | 637 | 635 |
| Tₚ/° C. | | | | | |
| Devitrification properties | ∘ | ∘ | ∘ | ∘ | ∘ |

TABLE 5

| | Number | | | | |
|---|---|---|---|---|---|
| | Run 21 | Run 22 | Run 23 | Run 24 | Run 25 |
| B₂O₃ | 17.4 | 18.8 | 18.4 | 18.4 | 18.4 |
| SiO₂ | 8.84 | 5.14 | 5.01 | 5.02 | 5.03 |
| La₂O₃ | 28.8 | 30.2 | 29.4 | 30.6 | 31.8 |
| Gd₂O₃ | 10.7 | 12.9 | 12.6 | 11.4 | 10.1 |
| ZnO | 13.1 | 14.4 | 14.0 | 14.1 | 14.1 |
| Li₂O | 2.00 | 1.62 | 1.58 | 1.58 | 1.58 |
| TiO₂ | 1.76 | 1.71 | 1.67 | 1.67 | 1.67 |
| ZrO₂ | 1.81 | 0.00 | 0.00 | 0.00 | 0.00 |
| Ta₂O₅ | 9.75 | 9.44 | 9.22 | 9.23 | 9.24 |
| Nb₂O₅ | 0.00 | 0.00 | 0.00 | 0.00 | 0.00 |
| WO₃ | 5.97 | 5.78 | 8.06 | 8.07 | 8.08 |
| Total | 100 | 100 | 100 | 100 | 100 |
| Network modification | 1.74 | 1.50 | 1.50 | 1.50 | 1.50 |
| ratio | | | | | |
| Refractive index n_{d} | 1.79 | 1.80 | 1.81 | 1.81 | 1.81 |
| Abbe number ν_{d} | 41.9 | 41.7 | 40.8 | 40.8 | 40.7 |
| Glass transition point | 554 | 560 | 560 | 556 | 555 |
| T_{g}/° C. | | | | | |
| Yield point Aₜ/° C. | 607 | 611 | 612 | 607 | 607 |
| Liquidus temperature | 980 | 990 | 970 | 980 | 990 |
| T_{L}/° C. | | | | | |
| Thermal expansion | 77.2 | 80.3 | 81.1 | 78.2 | 78.4 |
| coefficient α | | | | | |
| Molding temperature | 633 | 637 | 637 | 633 | 632 |
| Tₚ/° C. | | | | | |
| Devitrification properties | ∘ | ∘ | ∘ | ∘ | ∘ |

TABLE 6

| | Number | | | | |
|---|---|---|---|---|---|
| | Run 26 | Run 27 | Run 28 | Run 29 | Run 30 |
| B₂O₃ | 16.0 | 15.9 | 16.0 | 15.9 | 18.5 |
| SiO₂ | 8.13 | 8.06 | 8.14 | 8.08 | 5.04 |
| La₂O₃ | 29.8 | 31.1 | 30.9 | 32.3 | 31.9 |
| Gd₂O₃ | 11.0 | 11.5 | 9.8 | 10.3 | 11.4 |
| ZnO | 12.6 | 13.1 | 12.6 | 13.1 | 14.1 |
| Li₂O | 1.74 | 1.82 | 1.74 | 1.82 | 1.59 |
| TiO₂ | 1.62 | 1.69 | 1.62 | 1.70 | 1.68 |
| ZrO₂ | 1.67 | 1.74 | 1.67 | 1.74 | 0.00 |
| Ta₂O₅ | 12.0 | 9.37 | 12.0 | 9.38 | 9.27 |
| Nb₂O₅ | 0.00 | 0.00 | 0.00 | 0.00 | 0.00 |
| WO₃ | 5.49 | 5.73 | 5.50 | 5.74 | 6.49 |
| Total | 100 | 100 | 100 | 100 | 100 |
| Network modification | 1.69 | 1.60 | 1.69 | 1.60 | 1.50 |
| ratio | | | | | |
| Refractive index n_{d} | 1.81 | 1.81 | 1.81 | 1.81 | 1.81 |
| Abbe number ν_{d} | 41.0 | 41.3 | 41.0 | 41.2 | 42.8 |
| Glass transition point | 568 | 564 | 563 | 557 | 555 |
| T_{g}/° C. | | | | | |
| Yield point Aₜ/° C. | 621 | 617 | 615 | 610 | 606 |
| Liquidus temperature | 980 | 980 | 1000 | 990 | 1000 |
| T_{L}/° C. | | | | | |
| Thermal expansion | 79.6 | 81.9 | 78.5 | 79.9 | 79.9 |
| coefficient α | | | | | |
| Molding temperature | 648 | 644 | 641 | 636 | 632 |
| Tₚ/° C. | | | | | |
| Devitrification properties | ∘ | ∘ | ∘ | ∘ | ∘ |

TABLE 7

| | Number | | | | |
|---|---|---|---|---|---|
| | Run 31 | Run 32 | Run 33 | Run 34 | Run 35 |
| B₂O₃ | 18.5 | 18.4 | 18.6 | 16.4 | 17.8 |
| SiO₂ | 5.04 | 5.0 | 5.06 | 8.31 | 4.84 |
| La₂O₃ | 29.6 | 29.5 | 29.7 | 30.4 | 30.6 |
| Gd₂O₃ | 12.7 | 12.6 | 12.7 | 11.3 | 12.2 |
| ZnO | 13.5 | 13.5 | 14.2 | 12.8 | 13.6 |
| Li₂O | 1.59 | 1.69 | 1.59 | 1.78 | 1.52 |
| TiO₂ | 1.68 | 1.67 | 1.6 | 1.66 | 0.54 |
| ZrO₂ | 0.00 | 0.00 | 0.00 | 1.70 | 0.00 |
| Ta₂O₅ | 9.2 | 9.24 | 9.30 | 9.16 | 8.90 |
| Nb₂O₅ | 0.00 | 0.01 | 0.75 | 0.92 | 0.00 |
| WO₃ | 8.10 | 8.08 | 6.50 | 5.61 | 10.11 |
| Total | 100 | 100 | 100 | 100 | 100 |
| Network modification | 1.56 | 1.54 | 1.50 | 1.69 | 1.50 |
| ratio | | | | | |
| Refractive index n_{d} | 1.81 | 1.81 | 1.81 | 1.81 | 1.81 |
| Abbe number ν_{d} | 40.8 | 40.9 | 40.9 | 41.0 | 41.5 |
| Glass transition point | 558 | 558 | 556 | 567 | 557 |
| T_{g}/° C. | | | | | |
| Yield point Aₜ/° C. | 609 | 608 | 606 | 616 | 609 |
| Liquidus temperature | 980 | 980 | 980 | 980 | 990 |
| T_{L}/° C. | | | | | |
| Thermal expansion | 78.0 | 80.8 | 79.6 | 79.6 | 79.3 |
| coefficient α | | | | | |
| Molding temperature | 634 | 633 | 632 | 641 | 634 |
| Tₚ/° C. | | | | | |
| Devitrification properties | ∘ | ∘ | ∘ | ∘ | ∘ |

TABLE 8

| | Number | | | | |
|---|---|---|---|---|---|
| | Run 36 | Run 37 | Run 37 | Run 39 | Run 40 |
| B₂O₃ | 17.8 | 17.4 | 17.5 | 15.6 | 15.6 |
| SiO₂ | 4.85 | 4.75 | 4.76 | 7.90 | 7.92 |
| La₂O₃ | 31.7 | 30.1 | 31.2 | 30.0 | 32.2 |
| Gd₂O₃ | 11.0 | 12.0 | 10.8 | 11.9 | 9.6 |
| ZnO | 13.6 | 13.3 | 13.3 | 12.2 | 12.2 |
| Li₂O | 1.53 | 1.50 | 1.50 | 1.69 | 1.69 |
| TiO₂ | 0.54 | 0.00 | 0.00 | 0.53 | 0.53 |
| ZrO₂ | 0.00 | 0.00 | 0.00 | 1.62 | 1.62 |
| Ta₂O₅ | 8.91 | 8.74 | 8.75 | 8.71 | 8.73 |
| Nb₂O₅ | 0.00 | 0.00 | 0.00 | 0.00 | 0.00 |
| WO₃ | 10.1 | 12.2 | 12.2 | 9.91 | 9.93 |
| Total | 100 | 100 | 100 | 100 | 100 |
| Network modification | 1.50 | 1.50 | 1.50 | 1.69 | 1.69 |
| ratio | | | | | |
| Refractive index n_{d} | 1.81 | 1.81 | 1.81 | 1.81 | 1.81 |
| Abbe number ν_{d} | 41.2 | 41.3 | 41.2 | 41.4 | 41.4 |
| Glass transition point | 557 | 558 | 557 | 563 | 562 |
| T_{g}/° C. | | | | | |
| Yield point Aₜ/° C. | 608 | 609 | 609 | 616 | 615 |
| Liquidus temperature | 1000 | 980 | 980 | 1000 | 1000 |
| T_{L}/° C. | | | | | |
| Thermal expansion | 79.4 | 78.7 | 78.9 | 78.4 | 78.8 |
| coefficient α | | | | | |
| Molding temperature | 634 | 635 | 635 | 642 | 641 |
| Tₚ/° C. | | | | | |
| Devitrification properties | ∘ | ∘ | ∘ | ∘ | ∘ |

TABLE 9

| | Number | | | | |
|---|---|---|---|---|---|
| | Run 41 | Run 42 | Run 43 | Run 44 | Run 45 |
| B₂O₃ | 15.3 | 18.3 | 18.3 | 18.3 | 16.0 |
| SiO₂ | 7.75 | 4.99 | 4.99 | 4.98 | 8.12 |
| La₂O₃ | 30.9 | 29.3 | 28.2 | 27.0 | 28.6 |
| Gd₂O₃ | 11.1 | 12.5 | 13.8 | 15.0 | 12.3 |
| ZnO | 12.6 | 14.0 | 14.0 | 13.9 | 12.5 |
| Li₂O | 1.74 | 1.57 | 1.57 | 1.57 | 1.74 |
| TiO₂ | 0.54 | 1.66 | 1.66 | 1.65 | 1.62 |
| ZrO₂ | 1.67 | 0.43 | 0.43 | 0.43 | 1.67 |
| Ta₂O₅ | 8.99 | 9.18 | 9.17 | 9.15 | 12.0 |
| Nb₂O₅ | 0.00 | 0.00 | 0.00 | 0.00 | 0.00 |
| WO₃ | 9.44 | 8.02 | 8.01 | 8.00 | 5.49 |
| Total | 100 | 100 | 100 | 100 | 100 |
| Network modification | 1.60 | 1.50 | 1.50 | 1.50 | 1.69 |
| ratio | | | | | |
| Refractive index n_{d} | 1.81 | 1.81 | 1.81 | 1.81 | 1.81 |
| Abbe number ν_{d} | 41.3 | 40.8 | 40.8 | 40.8 | 41.0 |
| Glass transition point | 559 | 557 | 558 | 558 | 564 |
| T_{g}/° C. | | | | | |
| Yield point Aₜ/° C. | 612 | 609 | 609 | 610 | 616 |
| Liquidus temperature | 990 | 970 | 960 | 980 | 1000 |
| T_{L}/° C. | | | | | |
| Thermal expansion | 79.6 | 77.8 | 77.7 | 77.5 | 78.2 |
| coefficient α | | | | | |
| Molding temperature | 638 | 634 | 635 | 635 | 642 |
| Tₚ/° C. | | | | | |
| Devitrification properties | ∘ | ∘ | ∘ | ∘ | ∘ |

TABLE 10

| | Number | | | | |
|---|---|---|---|---|---|
| | Run 46 | Run 47 | Run 48 | Run 49 | Run 50 |
| B₂O₃ | 15.8 | 16.0 | 15.8 | 18.0 | 17.8 |
| SiO₂ | 8.02 | 8.11 | 8.00 | 5.40 | 5.80 |
| La₂O₃ | 29.7 | 27.5 | 28.6 | 29.3 | 29.2 |
| Gd₂O₃ | 12.7 | 13.5 | 14.0 | 12.5 | 12.5 |
| ZnO | 13.0 | 12.5 | 13.0 | 14.0 | 13.9 |
| Li₂O | 1.80 | 1.74 | 1.80 | 1.57 | 1.57 |
| TiO₂ | 1.68 | 1.62 | 1.68 | 1.66 | 1.65 |
| ZrO₂ | 1.73 | 1.66 | 1.73 | 0.4 | 0.43 |
| Ta₂O₅ | 9.31 | 11.9 | 9.30 | 9.16 | 9.14 |
| Nb₂O₅ | 0.00 | 0.00 | 0.00 | 0.00 | 0.00 |
| WO₃ | 6.19 | 5.48 | 6.18 | 8.01 | 8.00 |
| Total | 100 | 100 | 100 | 100 | 100 |
| Network modification | 1.60 | 1.69 | 1.60 | 1.51 | 1.52 |
| ratio | | | | | |
| Refractive index n_{d} | 1.81 | 1.81 | 1.81 | 1.81 | 1.81 |
| Abbe number ν_{d} | 41.2 | 41.1 | 41.2 | 40.9 | 40.8 |
| Glass transition point | 559 | 565 | 559 | 558 | 559 |
| T_{g}/° C. | | | | | |
| Yield point Aₜ/° C. | 611 | 616 | 611 | 610 | 610 |
| Liquidus temperature | 980 | 1000 | 980 | 970 | 960 |
| T_{L}/° C. | | | | | |
| Thermal expansion | 79.3 | 78.0 | 79.1 | 77.7 | 77.5 |
| coefficient α | | | | | |
| Molding temperature | 637 | 642 | 638 | 635 | 636 |
| Tₚ/° C. | | | | | |
| Devitrification properties | ∘ | ∘ | ∘ | ∘ | ∘ |

TABLE 11

| | Number | | | | |
|---|---|---|---|---|---|
| | Run 51 | Run 52 | Run 53 | Run 54 | Run 55 |
| B₂O₃ | 17.5 | 17.2 | 18.4 | 15.4 | 16.6 |
| SiO₂ | 6.21 | 6.61 | 5.01 | 7.80 | 7.90 |
| La₂O₃ | 29.2 | 29.1 | 29.4 | 25.4 | 29.3 |
| Gd₂O₃ | 12.5 | 12.5 | 12.6 | 16.5 | 12.5 |
| ZnO | 13.9 | 13.9 | 13.4 | 12.1 | 12.8 |
| Li₂O | 1.56 | 1.56 | 1.68 | 1.67 | 1.78 |
| TiO₂ | 1.65 | 1.65 | 1.66 | 0.52 | 1.66 |
| ZrO₂ | 0.42 | 0.42 | 0.43 | 1.60 | 1.70 |
| Ta₂O₅ | 9.13 | 9.11 | 9.20 | 8.61 | 9.17 |
| Nb₂O₅ | 0.00 | 0.00 | 0.19 | 0.00 | 0.92 |
| WO₃ | 7.98 | 7.97 | 8.05 | 10.5 | 5.61 |
| Total | 100 | 100 | 100 | 100 | 100 |
| Network modification | 1.53 | 1.54 | 1.54 | 1.69 | 1.68 |
| ratio | | | | | |
| Refractive index n_{d} | 1.81 | 1.81 | 1.81 | 1.81 | 1.81 |
| Abbe number ν_{d} | 40.9 | 40.9 | 40.8 | 41.2 | 41.1 |
| Glass transition point | 560 | 561 | 555 | 566 | 561 |
| T_{g}/° C. | | | | | |
| Yield point Aₜ/° C. | 611 | 612 | 606 | 618 | 613 |
| Liquidus temperature | 950 | 960 | 980 | 1000 | 980 |
| T_{L}/° C. | | | | | |
| Thermal expansion | 77.4 | 77.2 | 78.5 | 77.4 | 79.0 |
| coefficient α | | | | | |
| Molding temperature | 637 | 638 | 632 | 644 | 638 |
| Tₚ/° C. | | | | | |
| Devitrification properties | ∘ | ∘ | ∘ | ∘ | ∘ |

TABLE 12

| | Number | | | | |
|---|---|---|---|---|---|
| | Run 56 | Run 57 | Run 58 | Run 59 | Run 60 |
| B₂O₃ | 16.9 | 16.9 | 17.3 | 17.1 | 15.5 |
| SiO₂ | 5.99 | 5.99 | 6.12 | 6.07 | 7.87 |
| La₂O₃ | 28.1 | 28.2 | 28.8 | 29.4 | 28.1 |
| Gd₂O₃ | 12.0 | 12.1 | 12.3 | 12.7 | 13.7 |
| ZnO | 13.4 | 13.4 | 13.7 | 13.6 | 12.8 |
| Li₂O | 1.51 | 1.51 | 1.54 | 1.53 | 1.77 |
| TiO₂ | 0.53 | 0.53 | 0.54 | 0.54 | 1.10 |
| ZrO₂ | 0.41 | 0.41 | 0.42 | 0.42 | 1.70 |
| Ta₂O₅ | 10.3 | 11.8 | 10.6 | 10.4 | 9.13 |
| Nb₂O₅ | 0.00 | 0.00 | 0.90 | 0.36 | 0.37 |
| WO₃ | 10.8 | 9.25 | 7.88 | 7.81 | 7.99 |
| Total | 100 | 100 | 100 | 100 | 100 |
| Network modification | 1.53 | 1.53 | 1.53 | 1.53 | 1.60 |
| ratio | | | | | |
| Refractive index n_{d} | 1.81 | 1.81 | 1.81 | 1.81 | 1.81 |
| Abbe number ν_{d} | 41.0 | 41.0 | 41.3 | 41.7 | 41.0 |
| Glass transition point | 562 | 562 | 561 | 561 | 560 |
| T_{g}/° C. | | | | | |
| Yield point Aₜ/° C. | 615 | 614 | 612 | 612 | 612 |
| Liquidus temperature | 960 | 980 | 1000 | 980 | 980 |
| T_{L}/° C. | | | | | |
| Thermal expansion | 80.0 | 77.7 | 79.0 | 79.3 | 79.0 |
| coefficient α | | | | | |
| Molding temperature | 641 | 639 | 637 | 638 | 638 |
| Tₚ/° C. | | | | | |
| Devitrification properties | ∘ | ∘ | ∘ | ∘ | ∘ |

TABLE 13

| | Number | | | | |
|---|---|---|---|---|---|
| | Run 61 | Run 62 | Run 63 | Run 64 | Run 65 |
| B₂O₃ | 15.5 | 15.4 | 16.8 | 16.8 | 17.7 |
| SiO₂ | 7.88 | 7.80 | 5.97 | 5.96 | 5.78 |
| La₂O₃ | 29.2 | 28.9 | 28.1 | 28.0 | 28.0 |
| Gd₂O₃ | 12.5 | 12.4 | 12.0 | 12.0 | 13.7 |
| ZnO | 12.8 | 12.7 | 13.4 | 13.3 | 13.9 |
| Li₂O | 1.77 | 1.76 | 1.51 | 1.50 | 1.56 |
| TiO₂ | 1.10 | 0.55 | 0.79 | 0.53 | 1.92 |
| ZrO₂ | 1.70 | 1.68 | 0.41 | 0.41 | 0.42 |
| Ta₂O₅ | 9.15 | 10.6 | 10.3 | 10.8 | 9.11 |
| Nb₂O₅ | 0.37 | 0.36 | 0.00 | 0.00 | 0.00 |
| WO₃ | 8.00 | 7.92 | 10.8 | 10.7 | 7.96 |
| Total | 100 | 100 | 100 | 100 | 100 |
| Network modification | 1.60 | 1.60 | 1.53 | 1.53 | 1.52 |
| ratio | | | | | |
| Refractive index n_{d} | 1.81 | 1.81 | 1.81 | 1.81 | 1.81 |
| Abbe number ν_{d} | 40.8 | 41.3 | 40.6 | 40.9 | 40.4 |
| Glass transition point | 559 | 560 | 562 | 562 | 565 |
| T_{g}/° C. | | | | | |
| Yield point Aₜ/° C. | 612 | 612 | 614 | 615 | 615 |
| Liquidus temperature | 1000 | 990 | 960 | 970 | 960 |
| T_{L}/° C. | | | | | |
| Thermal expansion | 79.2 | 79.7 | 79.1 | 78.6 | 78.6 |
| coefficient α | | | | | |
| Molding temperature | 638 | 638 | 640 | 641 | 640 |
| Tₚ/° C. | | | | | |
| Devitrification properties | ∘ | ∘ | ∘ | ∘ | ∘ |

TABLE 14

| Number | Run 66 | Run 67 | Run 68 |
|---|---|---|---|
| B₂O₃ | 17.5 | 17.4 | 17.3 |
| SiO₂ | 5.73 | 6.19 | 6.13 |
| La₂O₃ | 27.7 | 29.1 | 28.8 |
| Gd₂O₃ | 13.6 | 12.4 | 12.3 |
| ZnO | 13.7 | 13.9 | 13.7 |
| Li₂O | 1.55 | 1.56 | 1.55 |
| TiO₂ | 1.63 | 1.97 | 1.63 |
| ZrO₂ | 0.42 | 0.42 | 0.42 |
| Ta₂O₅ | 10.2 | 9.10 | 10.2 |
| Nb₂O₅ | 0.00 | 0.00 | 0.00 |
| WO₃ | 7.89 | 7.96 | 7.89 |
| Total | 100 | 100 | 100 |
| Network modification ratio | 1.52 | 1.53 | 1.53 |
| Refractive index n_{d} | 1.81 | 1.81 | 1.81 |
| Abbe number ν_{d} | 40.6 | 40.4 | 40.9 |
| Glass transition point T_{g}/° C. | 563 | 563 | 564 |
| Yield point Aₜ/° C. | 616 | 615 | 615 |
| Liquidus temperature T_{L}/° C. | 970 | 970 | 970 |
| Thermal expansion coefficient α | 80.0 | 80.1 | 79.0 |
| Molding temperature Tₚ/° C. | 642 | 641 | 641 |
| Devitrification properties | ∘ | ∘ | ∘ |

TABLE 15

| Number | Run 69 | Run 70 | Run 71 | Run 72 |
|---|---|---|---|---|
| B₂O₃ | 23.1 | 12.7 | 19.0 | 19.0 |
| SiO₂ | 4.78 | 3.30 | 4.50 | 4.80 |
| La₂O₃ | 24.2 | 23.4 | 27.4 | 27.5 |
| Gd₂O₃ | 21.7 | 14.1 | 10.5 | 10.5 |
| ZnO | 14.1 | 19.6 | 15.4 | 16.1 |
| Li₂O | 1.19 | 1.20 | 2.10 | 2.00 |
| ZrO₂ | 3.92 | 2.80 | 3.30 | 3.30 |
| Ta₂O₅ | 7.05 | 10.4 | 12.5 | 13.0 |
| WO₃ | 0.00 | 4.80 | 5.30 | 3.30 |
| Na₂O | 0.00 | 0.50 | 0.00 | 0.00 |
| Al₂O₃ | 0.00 | 2.80 | 0.00 | 0.00 |
| CaO | 0.00 | 2.00 | 0.00 | 0.00 |
| BaO | 0.00 | 2.40 | 0.00 | 0.00 |
| MgO | 0.00 | 0.00 | 0.00 | 0.50 |
| Total | 100 | 100 | 100 | 100 |
| Network modification ratio | 1.82 | 0.77 | 1.34 | 1.31 |
| Refractive index n_{d} | 1.77 | Not | 1.79 | 1.80 |
| | | vitrified | | |
| Abbe number ν_{d} | 47.9 | | 43.4 | 42.6 |
| Glass transition point T_{g}/° C. | 587 | | 545 | 544 |
| Yield point Aₜ/° C. | 634 | | 595 | 596 |
| Liquidus temperature T_{L}/° C. | 970 | | Exceeding | Exceeding |
| | | | 1000 | 1000 |
| Thermal expansion coefficient | 75.5 | | 82.8 | 82.1 |
| α | | | | |
| Molding temperature Tₚ/° C. | 658 | | 620 | 622 |
| Devitrification properties | ∘ | | x | x |

Although the present invention has been described in detail and by reference to the specific embodiments, it is apparent to one skilled in the art that various modifications or changes can be made without departing the spirit and scope of the present invention.

This application is based on Japanese Patent Application No. 2006-249552 filed Sep. 14, 2006, the disclosure of which is incorporated herein by reference in its entity.

### INDUSTRIAL APPLICABILITY

An optical glass suitable as optical parts of digital cameras and the like, and additionally, glass substrates requiring high refractive index, such as substrates for increasing light extraction efficiency for organic LED can be provided.

1. An optical glass comprising, in mass % on oxide basis;
B₂O₃: 10 to 25%
SiO₂: 0.5 to 12%
La₂O₃; 17 to 38%
Gd₂O₃: 5 to 25%
ZnO: 8 to 20%
Li₂O: 0.5 to 3%
Ta₂O₅: 5 to 15%, and
WO₃: 3 to 15,
wherein the optical glass has a (SiO₂+B₂O₃)/(ZnO+Li₂O) value, which is a mass ratio of the total content of SiO₂ and B₂O₃ to the total content of ZnO and Li₂O, of from 1.35 to 1.90.

2. The optical glass as claimed in claim 1, having a refractive index n_{d} of from 1.79 to 1.83 and an Abbe number ν_{d} of from 38 to 45.

3. The optical glass as claimed in claim 1, having a value of a molding temperature (Tₚ), defined by the relational expression of a glass transition point (T_{g}) and a yield point (At): At +(At−T_{g})/2, of 650° C. or lower, and a liquidus temperature (T_{L}) of 1,000° C. or lower.

4. The optical glass as claimed in claim 1, having an average thermal expansion coefficient (α) of from 66×10⁻⁷ K⁻¹ to 82×10⁻⁷ K⁻¹.

5. A lens comprising the optical glass as claimed in claim 1.
